(19) United States
(12) Patent Application Publication
(10) Pub. No.: US 2011/0238821 A1
(43) Pub. Date: Sep. 29, 2011

(54) INFORMATION COMMUNICATIONS SYSTEM, INFORMATION PROCESSING DEVICE, INFORMATION PROCESSING METHOD, AND COMPUTER READABLE RECORDING MEDIUM

(75) Inventor: Hideki MATSUO, Nagoya-shi (JP)

(73) Assignee: BROTHER KOGYO KABUSHIKI KAISHA, NAGOYA-SHI (JP)

(21) Appl. No.: 13/051,423

(22) Filed: Mar. 18, 2011

(30) Foreign Application Priority Data
Mar. 23, 2010 (JP) 2010-066786

(51) Int. Cl. G06F 15/173

(52) U.S. Cl. 709/224

(57) ABSTRACT

An information processing device in an information communications system in which a plurality of networks which are connected each other, each network including a plurality of node devices connected to the network, includes: a first acquisition unit configured to acquire an amount of data uploaded from the node device, connected to a first network of the plurality of networks, to a second network of the plurality of networks; a second acquisition unit configured to acquire a total amount of uploaded data acquired by the first acquisition unit; a first determination unit configured to determine whether the total amount of uploaded data acquired by the second acquisition unit is greater than a threshold; and a control unit configured to suppress contents from being uploaded by the node device connected to the first network if the first determination unit determines that the total amount of uploaded data is greater than the threshold.

### CROSS REFERENCE OF APPLICATION

This application is based upon and claims the benefit of priority of Japanese Patent Application No. 2010-066786 filed on Mar. 23, 2010, the contents of which are incorporated herein by reference in its entirety.

### BACKGROUND

The disclosure relates to a communication system having plural node devices which can communicate with each other through a network.

In a communication system in an overlay network, if a node acquires contents, for example, a node device storing the requested contents transmits the contents to the node device requesting the contents.

A node device may be connected to a network such as a LAN (Local Area Network) or an access network. At this time, if the node device stores highly-popular contents or a large amount of contents, the node device is frequently asked for the contents by node devices connected to other networks. Since the node device has to frequently transmit the contents, the amount of data to be transmitted from the node device increases. Therefore, a large load is applied to communication devices or lines connecting the networks. Accordingly, it is necessary to grasp the amount of data of contents transmitted and received between the networks.

For example, a technique of collecting statistical information including an amount of data transmitted from an access network to a relay network is known. In this technique, an access device accessing the access network periodically notifies a carrier edge node of the statistical information.

### SUMMARY

However, the statistical information is periodically notified. Accordingly, the amount of data included in the statistical information received and stored by the carrier edge node may not reflect the amount of data actually transmitted up to that time. For this reason, it is difficult for the carrier edge node to accurately grasp the amount of data transmitted from the access network. In the above-mentioned technique, it is difficult to reduce the load of the communication devices or lines connecting the networks.

An aspect of the disclosure is to provide an information communications system, an information processing device, an information processing method, and a program, which can prevent contents from being transmitted excessively from a predetermined network to another network.

The aspect of the disclosure provides the following arrangements.

An information communications system comprising:

a plurality of networks which are connected each other, each network including a plurality of node devices connected to the network; and

an information processing device configured to acquire an amount of data by which contents are uploaded from a first network of the plurality of networks to a second network of the plurality of networks,

wherein the information processing device includes:

a first acquisition unit configured to acquire an amount of data uploaded from the node device connected to the first network;

a second acquisition unit configured to acquire a total amount of uploaded data acquired by the first acquisition unit;

a first determination unit configured to determine whether the total amount of uploaded data acquired by the second acquisition unit is greater than a threshold; and

a control unit configured to suppress contents from being uploaded by the node device connected to the first network in response to determining that the total amount of uploaded data is greater than the threshold by the first determination unit.

An information processing device used in an information communications system in which a plurality of networks which are connected each other, the network including a plurality of node devices connected to the network, comprising:

a first acquisition unit configured to acquire an amount of data uploaded from the node device, connected to a first network of the plurality of networks, to a second network of the plurality of networks;

a second acquisition unit configured to acquire a total amount of uploaded data acquired by the first acquisition unit;

a first determination unit configured to determine whether the total amount of uploaded data acquired by the second acquisition unit is greater than a threshold; and

a control unit configured to suppress contents from being uploaded by the node device connected to the first network in response to determining that the total amount of uploaded data is greater than the threshold by the first determination unit.

A method of communicating contents in an information communications system in which a plurality of networks which are connected each other, each network including a plurality of node devices connected to the network, the method comprising:

acquiring an amount of data uploaded from the node device, connected to a first network of the plurality of networks, to a second network of the plurality of networks;

acquiring a total amount of acquired uploaded data; determining whether the total amount of uploaded data is greater than a threshold; and

a control unit configured to suppress contents from being uploaded by the node device connected to the first network in response to determining that the total amount of uploaded data is greater than the threshold by the first determination unit.

A non-transitory computer readable recording medium storing a program to be installed in a node device in an information communications system in which a plurality of networks which are connected each other, in the case the program is installed in the node device, the program causing the node device to execute:

acquiring an amount of data uploaded from the node device, connected to a first network of the plurality of networks, to a second network of the plurality of networks;

acquiring a total amount of acquired uploaded data;

determining whether the total amount of uploaded data is greater than a threshold; and

a control unit configured to suppress contents from being uploaded by the node device connected to the first network in response to determining that the total amount of uploaded data is greater than the threshold by the first determination unit.

### BRIEF DESCRIPTION OF THE DRAWINGS

FIG. 1 is a diagram illustrating an example where node devices are connected to each other in a contents distribution and storage system S according to an embodiment.

FIG. 2 is a diagram schematically illustrating exemplary operations in the contents distribution and storage system S according to the embodiment.

FIG. 3 is a diagram schematically illustrating exemplary operations in the contents distribution and storage system S according to the embodiment.

FIG. 4 is a diagram schematically illustrating the configuration of node Nn.

FIGS. 5A and 5B are flowcharts illustrating the flow of processes of a control unit 21 of an ordinary node according to the embodiment.

FIGS. 6A and 6B are flowcharts illustrating the flow of processes of the control unit 21 of a representative node according to the embodiment.

FIGS. 7A and 7B are flowcharts illustrating the flow of processes of the control unit 21 of a representative node according to the embodiment.

### DESCRIPTION OF EXEMPLARY EMBODIMENTS

Hereinafter, an exemplary embodiment will be described with reference to the accompanying drawings. In the following embodiment, the invention is applied to a contents distribution and storage system.

### 1. Configuration and Operation of Contents Distribution and Storage System

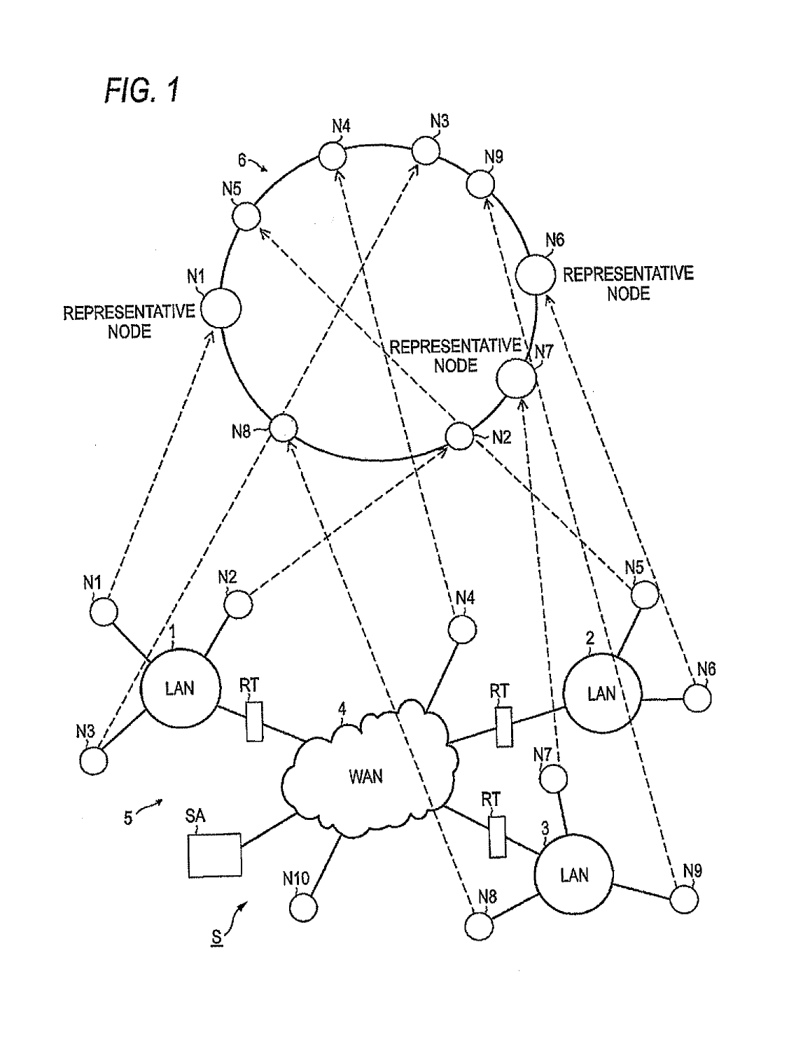

The brief configuration of a contents distribution and storage system according to an embodiment will be first described with reference to FIG. 1.

As shown in FIG. 1, the contents distribution and storage system S has a configuration in which plural node devices Nn (where n is one of 1, 2, 3, . . . ) are connected to each other through a network 5. The network 5 is a communication network in a real world. For example, the network 5 is the Internet. The network 5 includes plural LANm (where m is one of 1, 2, and 3) and a WAN (Wide Area Network) 4. A router RT mutually connecting the LANm and the WAN 4 is inserted into the network 5. Examples of the router RT include a broadband router and a firewall.

The node devices Nn are connected to the LANm or the WAN 4 constituting the network 5. Hereinafter, the node devices are referred to as “nodes”. A unique production number and a unique IP (Internet Protocol) address are assigned to each node. The contents distribution and storage system S according to this embodiment includes a peer-to-peer network system in which some nodes out of the nodes are connected to each other.

The peer-to-peer network is a network 6 shown in FIG. 1. The network 6 is an overlay network constructing a virtual link formed using the existing network 5. The network 6 which is a logical network is embodied by a specific algorithm such as an algorithm using DHT. Node IDs which are unique identification information including a predetermined number of digits are assigned to the nodes Nn connected to the contents distribution and storage system S.

The connection to the contents distribution and storage system S is carried out by causing a non-connected node, for example, node N8, to transmit an entry message indicating an entry request into the contents distribution and storage system to a connected arbitrary node. The entry into the contents distribution and storage system S means that a node is connected to the contents distribution and storage system S and can acquire contents data from the contents distribution and storage system S. The arbitrary node is, for example, a contact node always connected to the system S.

Each node stores a routing table using DHT. The routing table defines destinations of various messages in the contents distribution and storage system S. Specifically, plural pieces of node information including node IDs, IP addresses, and port numbers of the nodes properly separated in an ID space are registered in the routing table. A node connected to the contents distribution and storage system S stores the node information of the least necessary nodes in the routing table. By transmitting various messages between the nodes, the node information of the nodes Nn not storing the node information is acquired.

The contents distribution and storage system S distributes and stores copies of various contents data having different contents in predetermined file formats in the plural nodes. Hereinafter, the contents data is referred to as “contents”. The copies can be used among the nodes. The originals of the contents are stored in a center server SA. A node storing the copies of the contents is referred to as a “contents holding node”. In the following description, the original and the copies of contents are both referred to as “contents” without particularly distinguishing them. Information such as contents name and contents ID which is unique identification information of the contents is added to the contents.

The location of the contents distributed and stored is stored in a node managing (storing) the location of the contents as index information. Hereinafter, the node managing (storing) the location of the contents is referred to as a “root node”. The index information includes a set of the node information of the nodes storing the contents, the contents ID of the contents, and the like. The root node is determined, for example, to be a node having a node ID closest to the contents ID. The node ID closest to the contents ID is, for example, a node ID whose the high-order digits are most equal to those of the contents ID.

If a user of a node wants to acquire desired contents, the node from which the user wants to acquire the contents generates a message. Hereinafter, the node from which the user wants to acquire contents is referred to as a “user node”. This message is a search message including the contents ID of the contents to be acquired and the IP address of the user node. The search message is a message used to search for a contents holding node. The search message is sent to other nodes on the basis of the routing table using DHT acquired by the user node. That is, the user node sends out the search message to the root node. Accordingly, the search message finally arrives at the root node by the DHT routing using the contents ID as a key.

In each node, attribute information of the contents, such as the contents name and the contents ID, is described in the contents catalog information. The contents catalog information is prepared by the center server SA and is transmitted to all the nodes. The DHT routing is disclosed in Japanese Unexamined Patent Application Publication No. 2006-197400 which is incorporated herein by reference and is not therefore described in detail.

The root node having received the search message acquires index information corresponding to the contents ID included therein from an index information cache. The acquired index information is returned to the user node as the transmitting source of the search message. The user node having acquired the index information in this way can download (acquire) the contents on the basis of the index information. The user node transmits a contents request message to the contents holding node on the basis of the IP address and the port number of the contents holding node included in the index information. The contents request message includes the contents ID of the contents to be acquired. The contents holding node having received the contents request message transmits (uploads) the contents corresponding to the contents ID included in the contents request message to the user node. In this way, the user node can download the contents. The index information may include node information of plural contents holding nodes. In this case, the user node selects one contents holding node from the plural contents holding nodes. The user node can access the selected contents holding node and download the contents therefrom.

The root node may transmit a contents transmitting request message to the contents holding node indicated by the IP address included in the index information. Accordingly, the user node can download the contents from the contents holding node. The user node may acquire the index information from a cache node caching the same index information as the root node until the search message arrives at the root node.

If the user node acquires the contents from the contents holding node and stores the acquired contents, the user node generates a publication message. The publication message is a message used to inform the root node that the contents are stored. The publication message includes the contents ID of the contents and the node information of the node storing the contents. The publication message is sent to the root node. Accordingly, the publication message is made to arrive at the root node by the DHT routing using the contents ID as a key like the search message. The root node stores the index information including the set of the node information and the contents ID included in the publication message in an index information cache area. In this way, the user node becomes a new contents holding node holding the contents.

The contents holding node generates a retraction message, for example, at the time of deleting the stored contents. The retraction message is a message used to inform the root node that the publication of the contents is inhibited. The retraction message includes the contents ID of the deleted contents and the node information of the node having deleted the contents. The retraction message also arrives at the root node by the DHT routing using the contents ID as a key like the search message. The root node deletes the index information corresponding to the node information and the contents ID included in the retraction message from the index information caches area.

### 2. Limitation of Amount of Contents Data to be Uploaded

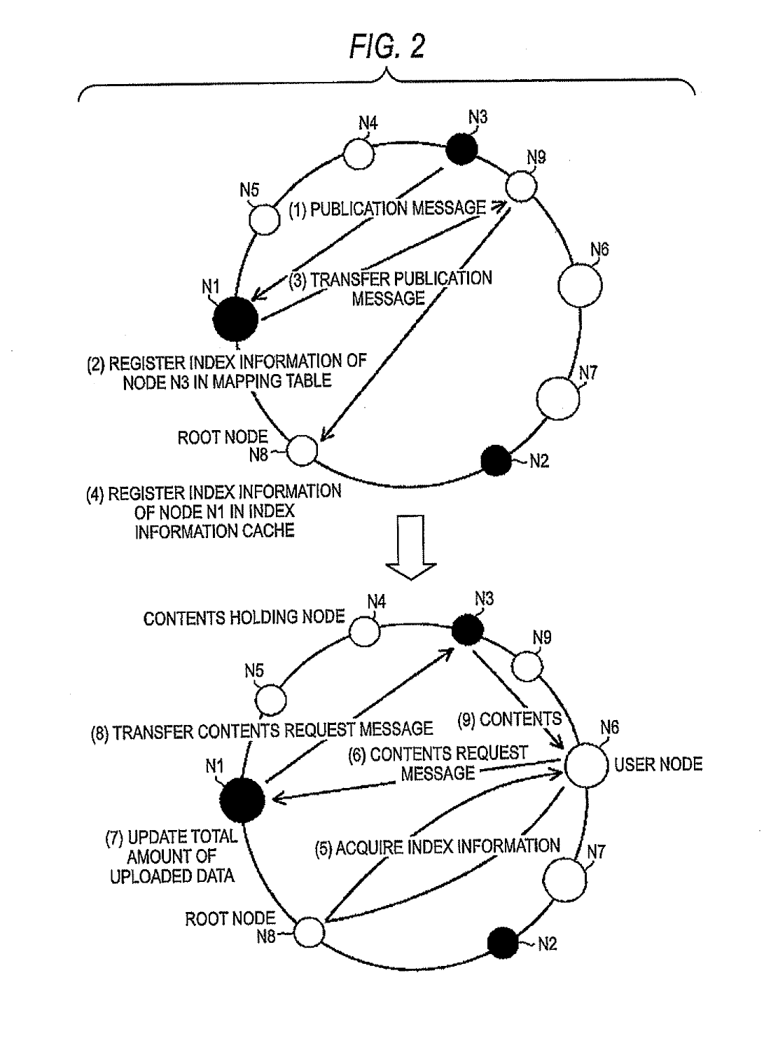

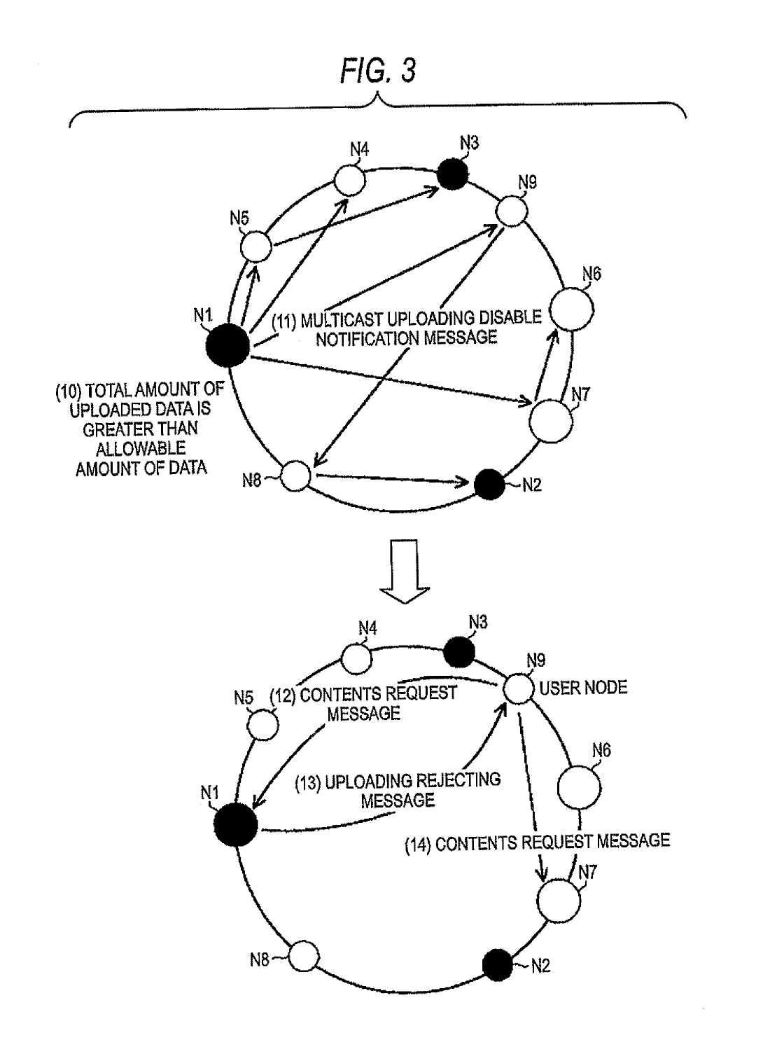

As shown in FIGS. 2 and 3, in the contents distribution and storage system S, a representative node of each LANm controls the uploading of contents from the inside of the LAN so as to prevent the contents from excessively being uploaded from the inside of the LAN to the outside of the LAN. Specifically, if the total amount of data uploaded from the inside of the LAN to the outside of the LAN for a counting period is greater than an allowable amount of data to be uploaded which is a predetermined threshold value, contents are not uploaded from the node Nn inside the LAN.

The node inside a LAN means a node connected to the same LANm as a certain node as viewed from the certain node. The node outside a LAN means a node not connected to the same LANm as a certain node as viewed from the certain node. The total amount of uploaded data is the total sum of the amounts of uploaded data by which contents are uploaded from the inside of a LAN to the outside of the LAN. The allowable amount of data to be uploaded is set in advance, for example, to a single value all over the system. The allowable amount of data to be uploaded may be set in advance to individual values of the LANm. The counting period is a period as a unit period in calculating the total amount of uploaded data. The total sum of the amounts of contents data uploaded for a certain counting period is the total amount of uploaded data for the counting period. The counting period is set in advance, for example, to individual values of the LANm. The counting period is, for example, a period with a length of 1 day or a period with a length of 1 hour.

For example, at least one representative node exists in each LANm. The representative node is determined from the nodes Nn connected to the same LANm. For example, from nodes N1, N2, and N3 connected to LAN1, node N1 is determined as the representative node. For example, from nodes N5 and N6 connected to LAN2, node N6 is determined as the representative node. Among nodes Nn connected to LANm, the nodes other than the representative node are referred to as “ordinary nodes”.

In order for the representative node to grasp the total amount of uploaded data in a LAN, a contents request message including the amount of data to be uploaded is sent to the representative node. Specifically, as shown in FIG. 2, node N3 which is an ordinary node transmits a publication message to node N1 which is a representative node (see (1) of FIG. 2). Node N1 having received the publication message registers the index information of node N3 in a LAN mapping table (see (2) of FIG. 2). The mapping table is a table in which the index information of nodes Nn in the LAN is registered, and is provided independently of the index information cache. The mapping table is held by the representative node. Node N1 transmits the publication message on the basis of the routing table (see (3) of FIG. 2). At this time, node N1 replaces the node information of node N3 included in the publication message with the node information of node N1. The root node, for example, node N8, having received the publication message registers the index information including the node information of node N1 included in the publication message in the index information cache (see (4) of FIG. 2).

The contents request message to be transmitted to node N3 is transmitted to node N1 due to the replacement of the node information by the representative node in the publication message. For example, node N6 which is a user node acquires the index information of the contents holding nodes from node N8 (see (5) of FIG. 2). The acquired index information includes the node information of node N1 instead of the node information of node N3. Accordingly, node N6 transmits the contents request message to node N1 (see (6) of FIG. 2). At this time, node N6 adds an uploading start position and an amount of data to be uploaded to the contents request message. The uploading start position and the amount of data to be uploaded are information indicating which part of the target contents to acquire. The uploading start position indicates an offset, which indicates a head position of the data to be uploaded, from the head of the contents. The amount of data to be uploaded indicates an amount of the data to be uploaded.

Node N1 adds the amount of data to be uploaded included in the received contents request message to the current total amount of uploaded data to update the total amount of uploaded data (see (7) of FIG. 2). If the updated total amount of uploaded data is equal to or less than an allowable amount of data to be uploaded, node Nn transfers the received contents request message to node N3 which is a contents holding node inside the LAN on the basis of the mapping table (see (8) of FIG. 2). Node N3 acquires the uploading start position and the amount of data to be uploaded included in the received contents request message. Then, node N3 uploads the contents to node N6 by data from the position indicated by the uploading start position to the position indicated by the amount of data to be uploaded (see (9) of FIG. 2).

If the total amount of uploaded data is greater than the allowable amount of data to be uploaded (see (10) of FIG. 3), node N1 suppresses the uploading of the contents from the LAN1. Specifically, node N1 multicasts an uploading disable notification message (see (11) of FIG. 3). Accordingly, the uploading disable notification message is received by all the node devices. For example, a DHT multicasting method disclosed in Japanese Unexamined Patent Application Publication No. 2007-053662 may be used as the multicasting method. The nodes having received the uploading disable notification message do not transmit the index information of node N1 to the user node thereafter. That is, node N1 does not transmit the index information of node N1 which is a root node and a contents holding node to a user node. Accordingly, contents are not uploaded from the nodes Nn inside the LAN.

Until the nodes transmit the uploading disable notification message after the total amount of uploaded data becomes greater than the allowable amount of data to be uploaded, a node may transmit a contents request message to node N1 (see (12) of FIG. 3). For example, node N3 transmits the contents request message to node N1. In this case, node N1 transmits an uploading rejecting message to node N3 (see (13) of FIG. 3). Then, node N3 transmits the contents request message to another contents holding node (see (14) of FIG. 3) and acquires the contents.

Thereafter, if the counting period has passed, a new counting period is started. Then, node N1 releases the suppression of the uploading of contents. Specifically, node N1 resets the total amount of uploaded data to zero. Then, node N1 transmits the uploading enable notification message to the nodes in a multicasting manner. The nodes having received the upload enable notification message can transmit the index information of node N1 which is considered as a root node and a contents holding node.

A node serving as a representative node is determined, for example, in advance. For example, a dedicated edge server device is determined as the representative node. In this case, a terminal device used by a user serves as an ordinary node. The representative node has a higher frequency of receiving the publication message, the retraction message, and the contents request message than the ordinary node does. Accordingly, for example, the processing speed of a CPU or the access speed of a RAM of the edge server device is set to be higher than that mounted on the terminal device. Accordingly, the processing speed of the edge server device on the received messages increases and thus the processes on the messages are smoothly performed.

### 3. Configuration of Node

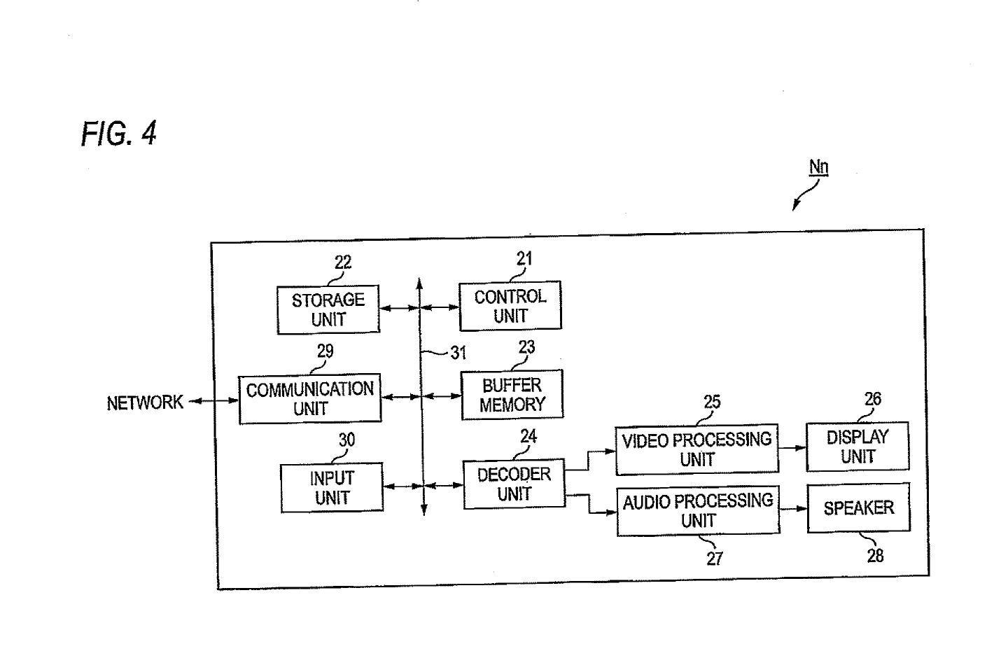

The configuration of a node will be described below with reference to FIG. 4. Each node includes a control unit 21. As shown in FIG. 4, the control unit 21 is a computer including a CPU having a calculation function, a working RAM, and a ROM storing various data and programs. Each node further includes a storage unit 22 and a buffer memory 23. The storage unit 22 is constructed by an HD (Hard Disk) storing various data and various programs. The buffer memory 23 temporarily stores copies of received contents. Each node further includes a decoder unit 24. The decoder unit 24 decodes encoded video data (video information) and audio data (audio information) included in a copy of contents. Each node further includes a video processing unit 25 and a display unit 26. The video processing unit 25 performs a predetermined drawing process on the decoded video data and outputs a video signal. The display unit 26 includes a CRT or a liquid crystal display displaying a video on the basis of the video signal output from the video processing unit 25. Each node further includes an audio processing unit 27 and a speaker 28. The audio processing unit 27 converts the decoded audio data into an analog audio signal in a D/A (Digital/Analog) conversion manner, amplifies the resultant signal by the use of an amplifier, and outputs the amplified signal. The speaker 28 outputs the audio signal output from the audio processing unit 27 as sound waves. Each node further includes a communication unit 29. The communication unit 29 controls the communication of information with other nodes through the network 5. Each node N11 further includes an input unit 30. The input unit 30 receives an instruction from a user and supplies an instruction signal corresponding to the received instruction to the control unit 21. The input unit 30 includes, for example, a keyboard, a mouse, a remote controller, or an operation panel. The control unit 21, the storage unit 22, the buffer memory 23, the decoder unit 24, the communication unit 29, and the input unit 30 are connected to each other through a bus 31. If the edge server device serves as a representative node, the input unit 20, the decoder unit 24, the video processing unit 25, the display unit 26, the audio processing unit 27, and the speaker 28 are not necessary for the configuration of the representative node.

The storage unit 22 stores the routing table using DHT, the index information, the uploading disable list, the address information of a contact node serving as an access destination at the time of entry into the contents distribution and storage system 5, and the address information of the center server SA. The storage unit 22 further stores downloaded contents in correlation with the contents IDs thereof.

If the node is a representative node, the storage unit 22 stores information pieces such as an allowable amount of data to be uploaded, a total amount of uploaded data at the current time, a LAN mapping table, and an uploading state. The uploading state is information indicating whether a node inside the LAN can upload contents.

The storage unit 22 further stores various programs such as an operating system and P2P software. For example, the P2P software includes the program according to the embodiment. The P2P software is software connected to the overlay network 6 to communicate with other nodes. For example, the P2P software for a representative node is installed in a representative node and the P2P software for an ordinary node is installed in an ordinary node. The P2P software may be downloaded, for example, from the center server SA. The P2P software may be recorded, for example, on a recording medium and may be read from the recording medium by the use of a drive.

### 4. Operation of Contents Distribution and Storage System

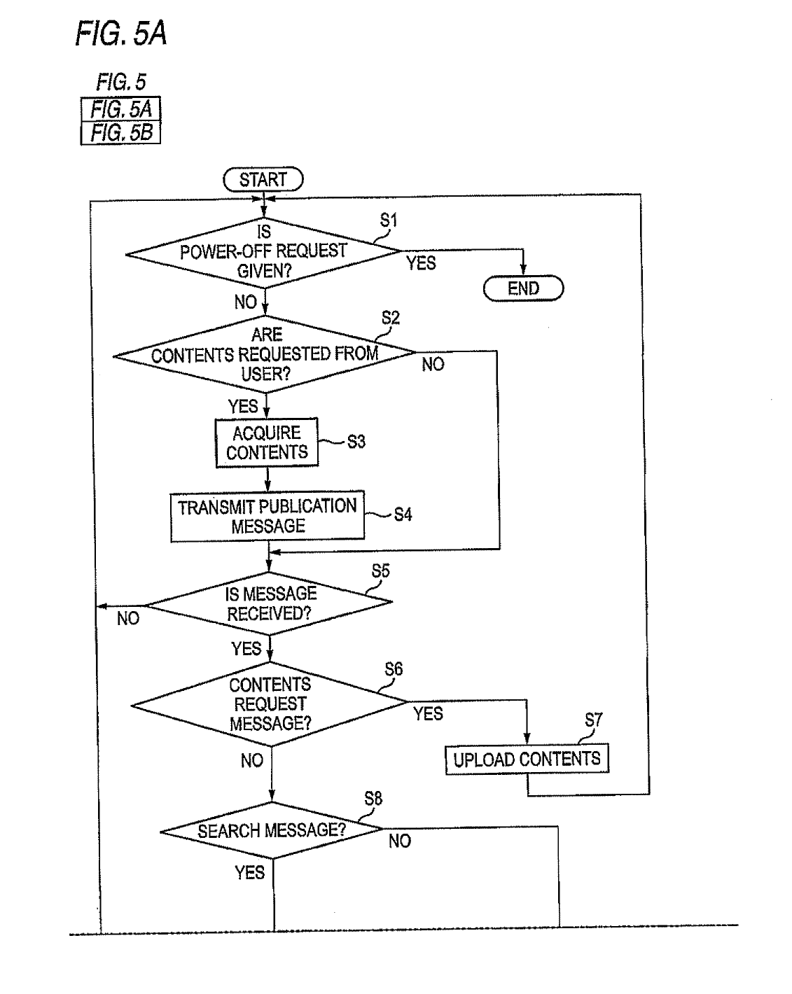

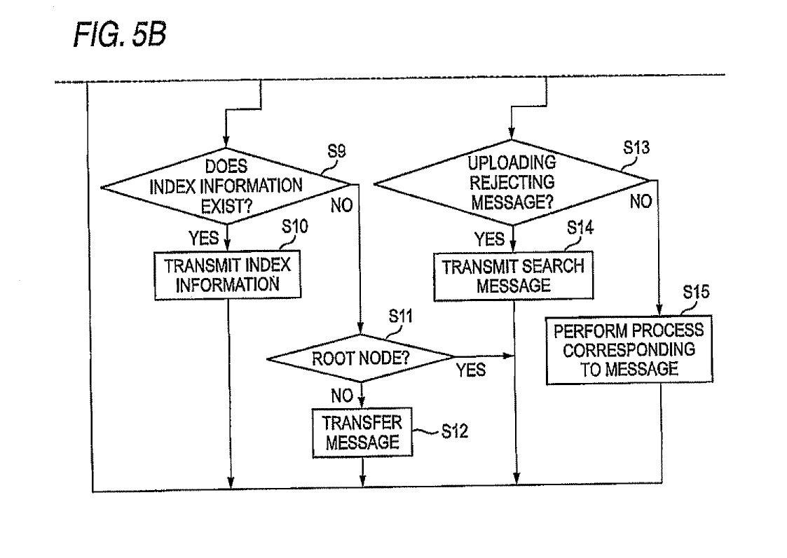

The operation of the contents distribution and storage system S according to this embodiment will be described below with reference to FIGS. 5 to 7. FIG. 5 is a flowchart illustrating the flow of processes of the control unit 21 of an ordinary node in this embodiment.

The flow of processes shown in FIG. 5 is started, for example, if an ordinary node is started up. First, the control unit 21 determines whether a power-off request is given by a user (step S1). If it is determined that the power-off request is not given (NO in step S1), the control unit 21 determines whether a request for contents is given by the user (step S2).

If the request for contents is given by the user (YES in step S2), the control unit 21 acquires the requested contents from the overlay network 6 (step S3). Specifically, the control unit 21 transmits a publication message to a root node. Thereafter, the control unit 21 receives the index information transmitted from the root node. Then, the control unit 21 serves as the transmitting unit to transmit a contents request message to a contents holding node on the basis of the received index information. The control unit 21 receives the contents transmitted from the contents holding node and stores the received contents in the storage unit 22. The control unit 21 having stored the contents transmits a publication message to a representative node (step S4).

If it is determined in step S2 that the request for contents is not given by the user (NO in step S2), or if the process of step S4 is finished, the control unit 21 determines whether a message is received from other nodes (step S5). If it is determined that no message is received (NO in step S5), the control unit 21 performs the process of step S1 again.

If it is determined a message is received (YES in step S5), the control unit 21 determines whether the received message is a contents request message (step S6). If it is determined that the received message is a contents request message (YES in step S6), the control unit 21 acquires the contents from the storage unit 22 and uploads the acquired contents to the node having transmitted the contents request message (step S7). At this time, the control unit 21 acquires the uploading start position and the amount of data to be uploaded included in the received contents request message. The control unit 21 uploads the contents to be uploaded by the amount of data from the position indicated by the uploading start position to the position indicated by the amount of data to be uploaded. The control unit 21 performs the process of step S1 again after performing the process of step S7.

If it is determined that the received message is not a contents request message (NO in step S6), the control unit 21 determines whether the received message is a search message (step S8). If it is determined that the received message is a search message (YES in step S8), the control unit 21 determines whether the index information corresponding to the contents ID included in the search message is registered in the index information cache (step S9). If it is determined that the index information corresponding to the contents ID included in the search message is registered in the index information cache (YES in step S9), the control unit 21 transmits the index information to the node having transmitted the search message (step S10). At this time, the control unit 21 does not transmit the index information corresponding to the node ID registered in the uploading disable list. The control unit 21 performs the process of step S1 again after performing the process of step S10.

If it is determined that the index information corresponding to the contents ID included in the search message is not registered in the index information caches (NO in step S9), the control unit 21 determines whether the ordinary node itself is the root node of the contents corresponding to the contents ID included in the search message (step S11). If it is determined that the ordinary node itself is not the root node (NO in step S11), the control unit 21 transfers a search message using the routing table (step S12). If it is determined in step S11 that the ordinary node itself is the root node (YES in step S11) or if the process of step S12 is performed, the control unit 21 performs the process of step S1 again.

If it is determined in step S8 that the received message is not the search message (NO in step S8), the control unit 21 determines whether the received message is an uploading rejecting message (step S13). If it is determined that the received message is an uploading rejecting message (YES in step S13), the control unit 21 transmits a search message to the root node again so as to acquire the contents from another node (step S14). The control unit 21 performs the process of step S1 again after performing the process of step S14.

If it is determined in step S13 that the received message is not the search message (NO in step S13), the control unit 21 performs the process corresponding to the received message (step S15) and then performs the process of step S1 again.

If it is determined in step S1 that a power-off request is given from the user (YES in step S1), the control unit 21 ends the flow of processes shown in FIG. 5.

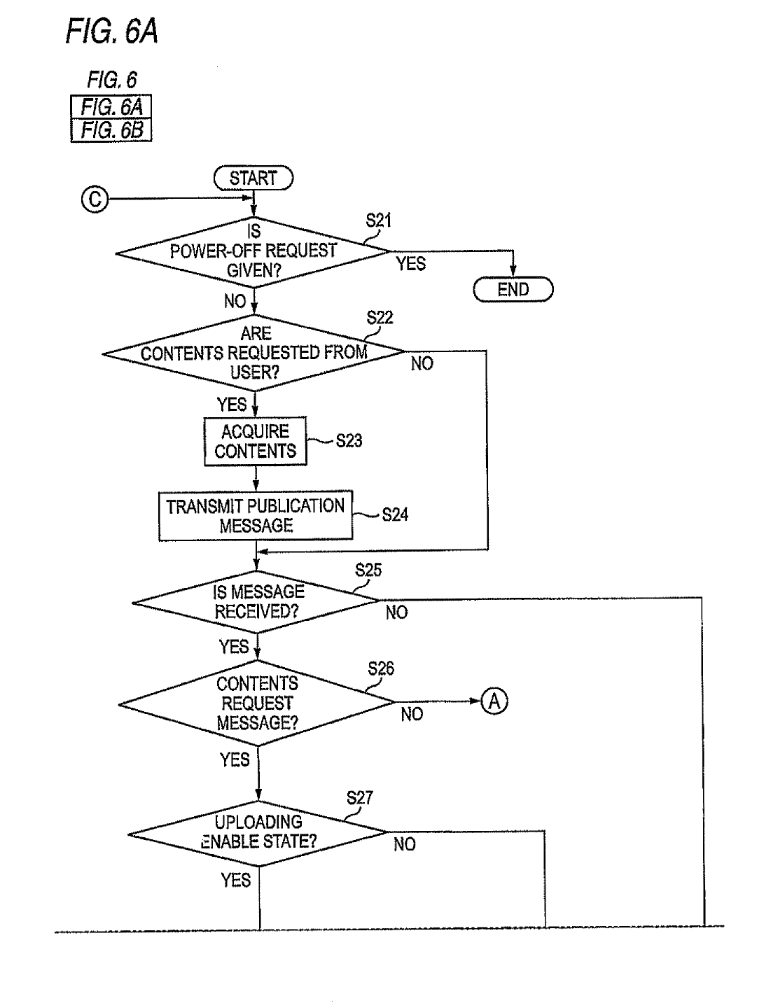

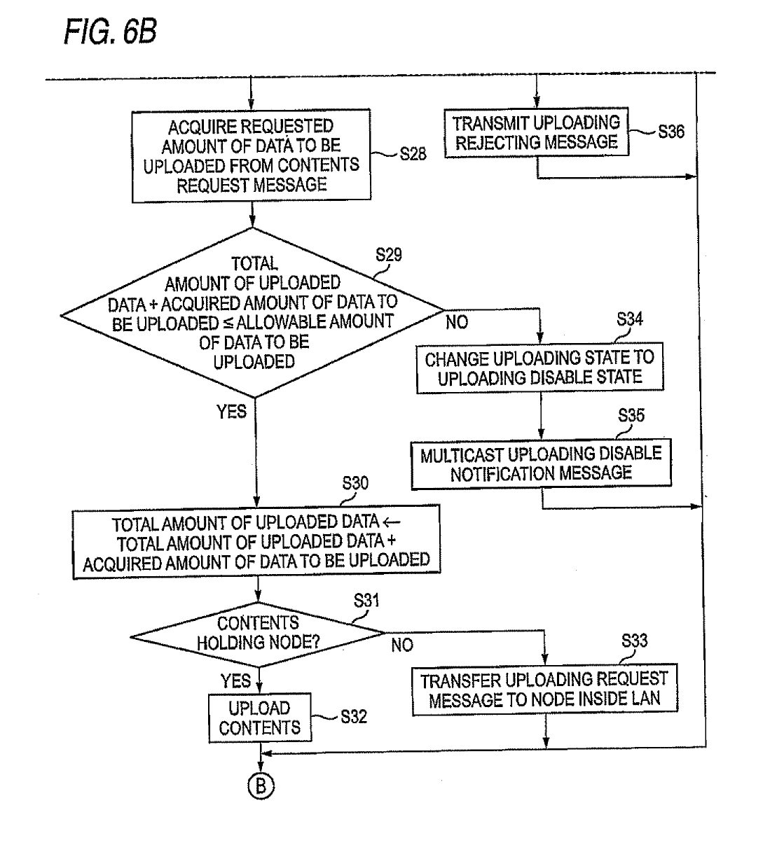

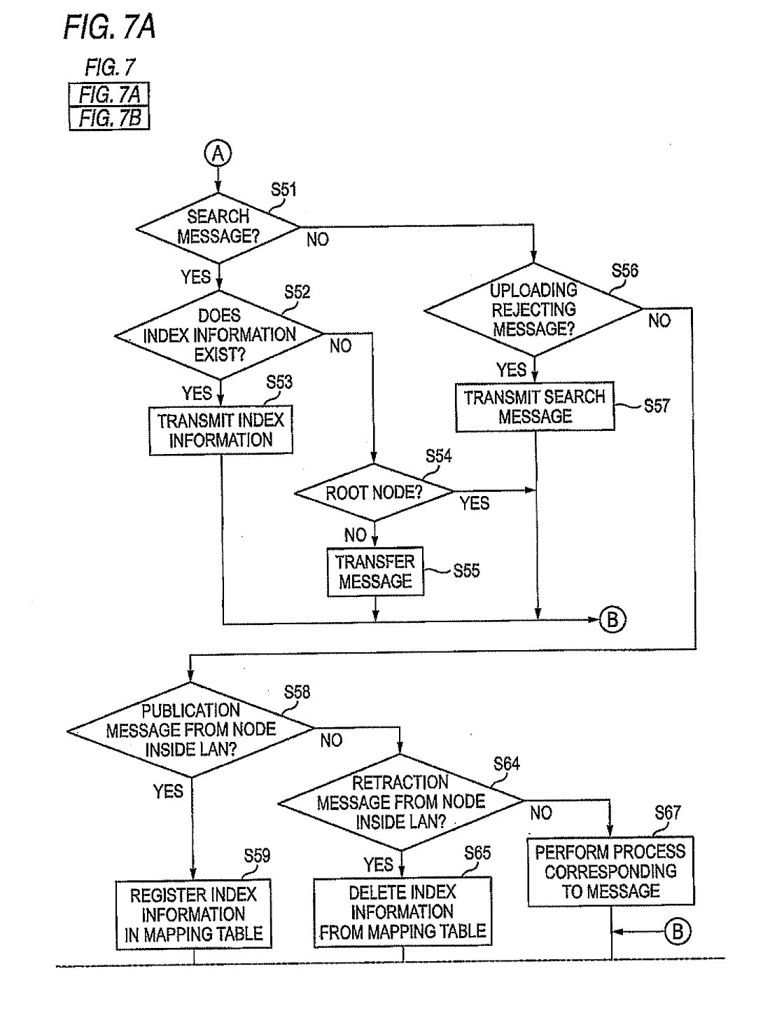

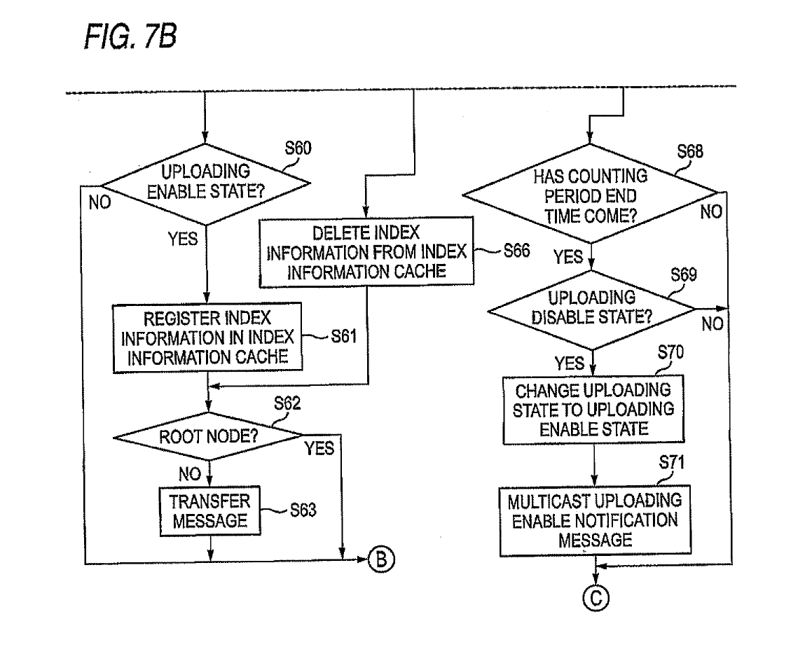

FIGS. 6 and 7 are flowcharts illustrating the flow of processes in the control unit 21 of the representative node according to this embodiment. The flow of processes shown in FIG. 6 is started, for example, if the representative node is started up. First, in steps S21 to S25, the control unit 21 performs the same processes as steps S1 to S5 shown in FIG. 5. If it is determined in step S25 that a message is not received from other nodes (NO in step S25), the control unit 21 performs the process of step S68 shown in FIG. 7.

If it is determined that a message is received (YES in step S25), the control unit 21 determines whether the received message is a contents request message (step S26). If it is determined that the received message is a contents request message (YES in step S26), the control unit 21 determines whether the current uploading state is an uploading enable state (step S27). If the uploading state stored in the storage unit 22 is the uploading enable state, it means that a node inside the LAN can upload contents. If the uploading state stored in the storage unit 22 is an uploading disable state, it means that the node inside the LAN cannot upload contents.

If it is determined that the uploading state is the uploading enable state (YES in step S27), the control unit 21 acquires the amount of data to be uploaded from the received contents request message (step S28). Subsequently, the control unit 21 calculates the sum of the current total amount of uploaded data and the acquired amount of data to be uploaded. Then, the control unit 21 determines whether the sum of the current total amount of uploaded data and the acquired amount of data to be uploaded is equal to or less than the allowable amount of data to be uploaded (step S29). If it is determined that the sum of the total amount of uploaded data and the acquired amount of data to be uploaded is equal or less than the allowable amount of data to be uploaded (YES in step S29), the control unit 21 adds the acquired amount of data to be uploaded to the total amount of uploaded data (step S30).

Subsequently, the control unit 21 determines whether the representative node itself is a contents holding node of the contents corresponding to the contents ID included in the received contents request message (step S31). If it is determined that the representative node itself is a contents holding node (YES in step S31), the control unit 21 uploads the contents stored in the storage unit 22 to the node having transmitted the contents request message (step S32). The details of the process of step S32 are the same as the process of step S7 shown in FIG. 5. If it is determined that the representative node itself is not a contents holding node (NO in step S31), the control unit 21 transfers the received contents request message to a node inside the LAN (step S33). Specifically, the control unit 21 acquires the index information corresponding to the contents ID included in the received contents request message from the mapping table. Then, the control unit 21 transfers the contents request message to the node indicated by the acquired index information. The control unit 21 performs the process of step S68 again after performing the process of step S32 or S33.

If it is determined in step S29 that the sum of the total amount of uploaded data and the acquired amount of data to be uploaded is greater than the allowable amount of data to be uploaded (NO in step S29), the control unit 21 changes the uploading state to the uploading disable state (step S34). Subsequently, the control unit 21 multicasts an uploading disable notification message (step S35). The uploading disable notification message includes the node ID of the representative node itself. The nodes having received the uploading disable notification message register the node ID included in the received uploading disable notification message in the uploading disable list. The control unit 21 performs the process of step S68 again after performing the process of step S35.

If it is determined in step S27 that the current uploading state is the uploading disable state (NO in step S27), the control unit 21 transmits an uploading rejecting message to the node having transmitted the contents request message (step S36). The control unit 21 performs the process of step S68 again after performing the process of step S36.

If it is determined that the received message is not a contents request message (NO in step S26), the control unit 21 performs the same processes as steps S8 to S14 shown in FIG. 5 in steps S51 to S57, as shown in FIG. 7. Here, if the index information is transmitted (step S53), if the search message is transferred (step S55), if it is determined that the representative node itself is a root node (YES in step S54), or if the search message is transmitted (step S57), the control unit 21 performs the process of step S68.

If it is determined in step S56 that the received message is not an uploading rejecting message (NO in step S56), the control unit 21 determines whether the received message is a publication message from a node inside the LAN (step S58). The message transmitted from a node outside the LAN and transferred to the representative node from a node inside the LAN is not included in the above-mentioned message from a node inside the LAN. For example, on the basis of the IP address of the node information included in the message, it can be determined whether the received message is the message from the node inside the LAN. The IP address includes a network address identifying a network and a host address identifying a host in the network. Accordingly, the control unit 21 compares the network address part of the local address of the representative node itself with the network address part of the IP address of the node information. If the network address parts are matched with each other, it is determined that the received message is a message transmitted from the node inside the LAN. The class of the IP address can be specified on the basis of the ID address. On the basis of the specified class, it can be determined what bits from the most significant bit of the IP address represents the network address. Alternatively, if a subnet mask is stored in the storage unit 22, it can be determined what bits from the most significant bit of the IP address represent the network address and the subnet address on the basis of the stored subnet mask. In this case, it is determined whether the network address and the subnet address are matched with each other.

If it is determined that the received message is a publication message from a node inside the LAN (YES in step S58), the control unit 21 registers the node information and the contents ID included in the publication message as the index information in the mapping table (step S59).

Subsequently, the control unit 21 determines whether the current uploading state is the uploading enable state (step S60). If it is determined that the uploading state is the uploading enable state (YES in step S60), the control unit 21 registers the index information in the index information cache (step S61). At this time, the control unit 21 replaces the node information included in the index information to be registered with the node information of the representative node itself. If it is determined that the uploading state is the uploading enable state, the contents can be uploaded from the node inside the LAN. The contents corresponding to the contents ID included in the search message received from another node by the representative node may be stored in the node inside the LAN. In this case, the index information including the node information of the representative node itself can be transmitted to the user node. Accordingly, the uploading request message from the user node is transmitted to the representative node.

Subsequently, the control unit 21 determines whether the representative node itself is a root node of the contents corresponding to the contents ID included in the publication message (step S62). If it is determined that the representative node itself is not a root node (NO in step S62), the control unit 21 transfers a publication message on the basis of the routing table (step S63). At this time, the control unit 21 replaces the node information included in the publication message with the node information of the representative node itself. If it is determined in step S60 that the uploading state is the uploading disable state (NO in step S60), if it is determined in step S62 that the representative node itself is a root node (YES in step S62), or if the process of step S63 is performed, the control unit 21 performs the process of step S68.

If it is determined in step S58 that the received message is not a publication message from node Nn inside the LAN (NO in step S58), the control unit 21 determines whether the received message is a retraction message from a node in the LAN (step S64). If it is determined that the received message is a retraction message from a node inside the LAN (YES in step S64), the control unit 21 deletes the index information corresponding to the node information and the contents ID included in the retraction message from the mapping table (step S65). Then, the control unit 21 deletes the index information from the index information caches (step S66). The control unit 21 performs the process of step S62 after performing the process of step S66. If the representative node itself is the root node of the contents corresponding to the contents ID included in the retraction message, the control unit 21 transfers the retraction message on the basis of the routing table. In this case, the control unit 21 also replaces the node information included in the retraction message with the node information of the representative node itself.

If it is determined in step S64 that the received message is not a retraction message from a node inside the LAN (NO in step S64), the control unit 21 performs the process corresponding to the received message (step S67) and then performs the process of step S68.

In step S68, the control unit 21 determines whether the end time of the counting period is reached (step S68). If it is determined that the end time of the counting period is reached (YES in step S68), the control unit 21 determines whether the current uploading state is an uploading disable state (step S69). If it is determined that the uploading state is an uploading disable state (YES in step S69), the control unit 21 changes the uploading state to the uploading enable state (step S70). At this time, the control unit 21 resets the total amount of uploaded data to zero. Subsequently, the control unit 21 multicasts an uploading enable notification message (step S71). The uploading enable notification message includes the node ID of the representative node itself. The nodes having received the uploading enable notification message deletes the node ID included in the uploading enable notification message from the uploading disable list. If it is determined in step S68 that the end time of the counting period is not reached (NO in step S68), if it is determined in step S69 that the uploading state is the uploading enable state (NO in step S69), or if the process of step S71 is performed, the control unit 21 performs the process of step S21.

If it is determined in step S21 that the power-off request is given from the user (YES in step S21), the control unit 21 ends the flow of processes shown in FIGS. 6 and 7.

According to the above-mentioned embodiment, the representative node acquires the total amount of uploaded data from the inside of the LAN to the outside of the LAN. If the representative node determines that the total amount of uploaded data is greater than the allowable amount of data to be uploaded, the uploading of contents from a node inside the LAN is suppressed. Accordingly, it is possible to prevent contents from excessively being transmitted from the inside of the LAN to the outside of the LAN. The representative node receives the contents request message, which represents a request for contents, transmitted from a connected node outside the LAN. The representative node acquires the amount of data to be uploaded of the contents corresponding to the contents ID included in the received contents request message. Accordingly, the representative node can recognize that the contents are uploaded from the inside of the LAN. Therefore, the representative node can accurately grasp the amount of uploaded data. The representative node acquires as the amount of uploaded data the amount of data included in the received contents request message. Accordingly, the representative node can accurately grasp the amount of contents data transmitted from the inside of the LAN to the outside of the LAN. The representative node need not monitor the amount of data of the actually transmitted contents, thereby reducing the processing load of the representative node.

If the representative node receives a publication message from an ordinary node inside the LAN, the representative node replaces the node information included in the received publication message with the node information of the representative node and transfers the publication message to the root node. Accordingly, the contents stored in a node inside the LAN are managed by the root node as being stored in the representative node. As a result, the representative node can receive a contents request message. Therefore, it is possible to accurately grasp the amount of data of the contents transmitted from the inside of the LAN to the outside of the LAN. After determining that the total amount of uploaded data is greater than the allowable amount of data to be uploaded, the representative node determines whether counting period has passed. If determining that the counting period has passed, the representative node releases the suppression of the uploading of contents. Therefore, with the passing of the counting period, the node inside the LAN can upload contents.

If it is determined that the total amount of uploaded data is greater than the allowable amount of data to be uploaded, the representative node multicasts the uploading disable notification message to the nodes. Accordingly, if the root node receives the uploading disable notification message, it is possible to suppress a contents request message from being transmitted to the representative node. It is not necessary to notify that contents cannot be uploaded for every contents. If it is determined that the total amount of uploaded data is greater than the allowable amount of data to be uploaded, the representative node transmits an uploading rejecting message to the node having transmitted the contents request message. Accordingly, if the user node receives the uploading rejecting message, the user node can recognize that it cannot acquire the contents from the nodes inside the LAN. As a result, the uploading of contents from the nodes inside the LAN is suppressed.

In the above-mentioned embodiment, a node serving as the representative node is determined in advance. However, for example, from nodes entering into the contents distribution and storage system S in the same LAN, a node earliest entering into the contents distribution and storage system S may be determined as the representative node. Specifically, for example, nodes entering into the contents distribution and storage system S register the node information of the nodes themselves and the current time as the entry time in a predetermined entry table stored in the nodes in correlation with each other. The nodes transmit an entry notification message including the node information and the entry time of the nodes themselves to the nodes Nn inside the LAN in an L2 broadcast manner.

If a node having received the entry notification message enters into the contents distribution and storage system S at that time, the node registers the node information and the entry time included in the entry notification message in the entry table stored in the node itself in correlation with each other. The node entering into the contents distribution and storage system S at that time transmits a response message including the node information of the node itself and the entry time to the node having transmitted the entry notification message. If a node having received the entry notification message does not enter into the contents distribution and storage system S at that time, the node discards the entry notification message.

If a node Nn entering into the contents distribution and storage system S does not receive any response message for a predetermined period, the node becomes the representative node. If a node receives the response messages from the nodes, the node registers the node information and the entry time included in the response messages in the entry table stored in the node itself. Then, the node sets the node information whose entry time is earliest based on the entry times registered in the entry table as the node information of the representative node. Thereafter, the node transmits a message to the representative node on the basis of the node information of the representative node.

If a node entering into the contents distribution and storage system S withdraws from the contents distribution and storage system S, the node transmits a withdrawal notification message including the node information of the node itself to the nodes inside the LAN in an L2 broadcast manner. If a node having received the withdrawal notification message enters into the contents distribution and storage system S at that time, the node deletes the node information included in the withdrawal notification message and the entry time correlated with the node information from its entry table. Then, the node sets the node information whose entry time is earliest out of the entry times registered in the entry table at that time as the node information of the representative node. If the entry time of the node itself is the earliest or if only the node information of the node itself remains in the entry table, the node is set as the representative node. Accordingly, a specific node inside the LAN need not always enter into the contents distribution and storage system S as the representative node.

In the above-mentioned embodiment, if an uploading state is an uploading enable state and a representative node receives a contents request, the representative node itself transmits a contents transmitting accepting or rejecting message. However, the representative node may notify several ordinary nodes inside the LAN of the contents transmitting accepting or rejecting message and may cause the ordinary nodes to transmit the contents transmitting accepting or rejecting message.

In the above-mentioned embodiment, ordinary nodes serve as the contents holding nodes to upload contents directly to a user node outside the LAN. However, the ordinary nodes may upload the contents to the user node outside the LAN through the representative node inside the LAN. In this case, the representative node relays the contents uploaded from an ordinary node inside the LAN to the user node.

If the representative node relays the contents, the amount of data of the relayed contents may be acquired as the amount of data to be uploaded instead of acquiring the amount of data to be uploaded from the contents request message. In this case, the representative node can accurately grasp the total amount of uploaded data. In case of a so-called push-type distribution in which contents are uploaded from the ordinary nodes to the outside of the LAN without receiving the contents request message, the representative node can grasp the amount of uploaded data.

If a representative node multicasts an uploading disable notification message, the time if the counting period in which the uploading is suppressed is ended may be included in the uploading disable notification message. In this case, a node having received the uploading disable notification message registers the node ID and the time included in the uploading disable notification message in its uploading disable list in correlation with each other. If the time registered in the uploading disable list passes, the node deletes the node ID and the time from the uploading disable list. Accordingly, the representative node need not transmit the uploading disable notification message.

The representative node does not multicast the uploading disable notification message, but the nodes may be notified that contents cannot be uploaded by other methods. For example, the representative node may transmit a retraction message by the contents whose index information is registered in the mapping table. In this case, the representative node adds the node information of the representative node itself and the contents ID of the contents whose index information is registered in the mapping table to the retraction message. In this case, if the end time of the counting period passes, the representative node transmits a publication message by the contents whose index information is registered instead of transmitting the uploading enable notification message.

The representative node may inquire of the ordinary nodes the contents ID of the contents stored in the ordinary nodes inside the LAN. The representative node may transmit the retraction message every contents ID acquired from the ordinary nodes. The number of index information pieces which can be registered in the mapping table of the representative node may be limited. In this case, if the number of contents stored in the ordinary nodes inside the LAN is greater than the upper limit, all the index information may not be registered in the mapping table. Even in such a case, the representative node can transmit the retraction messages of all the contents stored in the ordinary nodes inside the LAN.

The representative node may transmit the uploading disable notification message by contents in a unicast manner instead of transmitting the retraction messages. In this case, the representative node adds the node information of the representative node and the contents ID to the uploading disable notification message. The uploading disable notification message transmitted from the representative node arrives at the root node by the DHT routing. Then, the root node sets flag information indicating that the uploading is disabled, in correlation with the index information corresponding to the node information and the contents ID included in the uploading disable notification message. Thereafter, the root node does not transmit the index information in which the flag information is set to the user node. If the end time of the counting period is reached, the representative node transmits the uploading enable notification message by contents in the unicast manner. In this case, the representative node also adds the node information of the representative node itself and the contents ID to the uploading enable notification message. The uploading enable notification message transmitted from the representative node also arrives at the root node by the DHT routing. The root node deletes the flag information correlated with the index information corresponding to the node information and the contents ID included in the uploading enable notification message. In this case, the representative node may add the end time of the counting period to the uploading disable notification message.

In the above-mentioned embodiment, if the representative node receives a contents request message and the uploading state is the uploading disable state, the representative node returns an uploading rejecting message. However, the representative node may simply discard the contents request message. That is, the representative node may not transmit the uploading rejecting message nor the contents request message. In this case, the user node can transmit a contents request message to another node if contents are not uploaded even in a predetermined time after transmitting the contents request message.

The representative node may transfer the received contents request message to a node outside the LAN instead of returning the uploading rejecting message. In this case, the representative node transmits a search message including the contents ID included in the contents request message to the root node and acquires the index information. The representative node selects the index information of the contents holding node other than the representative node from the acquired index information. Then, the representative node transfers the contents request message to the contents holding node indicated by the selected index information. In this case, the user node can acquire the contents from the contents holding node as a destination of the contents request message.

In the above-mentioned embodiment, ordinary nodes are connected to the overlay network 6. However, only the representative node out of the nodes connected to the LANm may be connected to the overlay network 6. In this case, the ordinary nodes transmit a search message to the representative node if transmitting a message to be transferred by the DHT routing, for example, the search message. The representative node can transfer the received search message to the root node.

In the above-mentioned embodiment, an LAN is applied as the predetermined network according to the invention. However, for example, an access network constructed by an ISP (Internet Service Provider) providing an access service to the Internet or the like may be applied as the predetermined network according to the invention.

In the above-mentioned embodiment, a peer-to-peer network using DHT is applied to the overlay network, but the invention is not limited to this configuration. For example, another peer-to-peer system or a system using an overlay network may be applied. An example of the peer-to-peer system not using DHT is a hybrid peer-to-peer system. In the hybrid peer-to-peer system, a predetermined server device manages the locations of all contents. In this case, if the total amount of uploaded data is greater than the allowable amount of data to be uploaded, the representative node can transmit an uploading disable notification message to the predetermined server device.

What is claimed is:

1. An information communications system comprising:
a plurality of networks which are connected each other, the network including a plurality of node devices connected to the network; and
an information processing device configured to acquire an amount of data by which contents are uploaded from a first network of the plurality of networks to a second network of the plurality of networks,
wherein the information processing device comprises:
a first acquisition unit configured to acquire an amount of data uploaded from the node device connected to the first network;
a second acquisition unit configured to acquire a total amount of uploaded data acquired by the first acquisition unit;
a first determination unit configured to determine whether the total amount of uploaded data acquired by the second acquisition unit is greater than a threshold; and
a control unit configured to suppress contents from being uploaded by the node device connected to the first network in response to determining that the total amount of uploaded data is greater than the threshold by the first determination unit.

2. The information communications system according to claim 1, wherein
a node device connected to the second network comprises a transmitting unit configured to transmitting a request message indicating a request for the contents to the information processing device,
the information processing device further comprises a reception unit configured to receive the request message transmitted from the node device, and
the first acquisition unit acquires an amount of data to be uploaded of the requested contents indicated by the request message received by the reception unit.

3. The information communications system according to claim 2, wherein
the transmitting unit transmits the request message including the amount of data to be uploaded, and
the first acquisition unit acquires the amount of data included in the request message received by the reception unit as the amount of data to be uploaded.

4. The information communications system according to claim 1, wherein
the node device connected to the first network includes an uploading unit configured to upload contents to the node device connected to the second network through the information processing device,
the information processing device further comprises a relay unit configured to relay the contents uploaded from the node device, and
the first acquisition unit acquires the amount of data of the contents relayed by the relay unit as the amount of data to be uploaded.

5. The information communications system according to claim 1, wherein
contents are distributed and stored in an overlay network including the plurality of node devices connected to the network, and
the information processing device is one of the plurality of node devices constituting the overlay network.

6. An information processing device used in an information communications system in which a plurality of networks which are connected each other, the network including a plurality of node devices connected to the network, comprising:
a first acquisition unit configured to acquire an amount of data uploaded from the node device, connected to a first network of the plurality of networks, to a second network of the plurality of networks;
a second acquisition unit configured to acquire a total amount of uploaded data acquired by the first acquisition unit;
a first determination unit configured to determine whether the total amount of uploaded data acquired by the second acquisition unit is greater than a threshold; and
a control unit configured to suppress contents from being uploaded by the node device connected to the first network in response to determining that the total amount of uploaded data is greater than the threshold by the first determination unit.

7. The information processing device according to claim 6 further comprising:
a reception unit configured to receive a request message, which indicates a request for contents, transmitted from the node device connected to the second network,
wherein the first acquisition unit acquires an amount of data to be uploaded of the requested contents indicated by the request message received by the reception unit.

8. The information processing device according to claim 7, wherein
the reception unit receives the request message including the amount of data to be uploaded, and
the first acquisition unit acquires the amount of data included in the request message received by the reception unit as the amount of data to be uploaded.

9. The information processing device according to claim 7 further comprising a second transmitting unit configured to transmit a publication message, which indicates a publication that the contents stored in the node device connected to the first network is stored in the information processing device, to a managing device managing a location of the contents.

10. The information processing device according to claim 6, wherein the control unit transmits a disable message, which indicates that the contents cannot be uploaded, to the node device in response to determining that the total amount of uploaded data is greater than the threshold by the first determination unit.

11. The information processing device according to claim 10, wherein the control unit multicasts the disable message to the plurality of node devices.

12. The information processing device according to claim 6, wherein
the plurality of node devices in the information communications system distributes and manages locations of a plurality of pieces of contents for each contents, and
the control unit transmits a disable message, which indicates that the contents stored in the node device connected to the first network cannot be uploaded, to the node device managing the locations of the contents for each piece of contents in response to determining that the total amount of uploaded data is greater than the threshold by the first determination unit.

13. The information processing device according to claim 10, wherein the control unit transmits the disable message including time information indicating a time of releasing the suppression of the uploading of contents.

14. The information processing device according to claim 7 further comprising a transfer unit configured to transfer the request message received by the reception unit to the node devices connected to the first network,
wherein the control unit controls the transfer unit not to transfer the request message in response to determining that the total amount of uploaded data is greater than the threshold by the first determination unit.

15. The information processing device according to claim 7, wherein the control unit transmits a rejecting message, which indicates that the transmitting of contents is rejected, to the node device having transmitted the request message received by the reception unit or controls the node device connected to the first network to transmit the rejecting message to the node device having transmitted the request message, in response to determining that the total amount of uploaded data is greater than the threshold by the first determination unit.

16. The information processing device according to claim 7, wherein the control unit transfers the request message received by the reception unit to the node device connected to the second network if the first determination unit determines that the total amount of uploaded data is greater than the threshold.

17. The information processing device according to claim 6 further comprising a relay unit configured to relay contents uploaded from the node device connected to the first network to the node device connected to the second network,
wherein the first acquisition unit acquires the amount of data of the contents relayed by the relay unit as the amount of data to be uploaded.

18. The information processing device according to claim 6 further comprising a second determination unit configured to determine whether a predetermined period has passed since the first determination unit determines that the total amount of uploaded data is greater than the threshold,
wherein the control unit releases the suppression of the transmitting of contents in response to determining that the predetermined period has passed by the second determination unit.

19. A method of communicating contents in an information communications system in which a plurality of networks which are connected each other, the network including a plurality of node devices connected to the network, the method comprising:
acquiring an amount of data uploaded from the node device, connected to a first network of the plurality of networks, to a second network of the plurality of networks;
acquiring a total amount of acquired uploaded data;
determining whether the total amount of uploaded data is greater than a threshold; and
a control unit configured to suppress contents from being uploaded by the node device connected to the first network in response to determining that the total amount of uploaded data is greater than the threshold by the first determination unit.

20. A non-transitory computer readable recording medium storing a program to be installed in a node device in an information communications system in which a plurality of networks which are connected each other, in the case the program is installed in the node device, the program causing the node device to execute:
acquiring an amount of data uploaded from the node device, connected to a first network of the plurality of networks, to a second network of the plurality of networks;
acquiring a total amount of acquired uploaded data;
determining whether the total amount of uploaded data is greater than a threshold; and
a control unit configured to suppress contents from being uploaded by the node device connected to the first network if the first determination unit determines that the total amount of uploaded data is greater than the threshold.
